(19) United States
(12) Patent Application Publication
(10) Pub. No.: US 2026/0303758 A1
(43) Pub. Date: Oct. 1, 2026

(54) ONLINE MEETING SUMMARIES WITH INTEGRATED SUMMARIZED VISUAL CONTENT

(71) Applicant: Cisco Technology, Inc., San Jose, CA (US)

(72) Inventors: Ashly Joseph, Fremont, CA (US); Kirti Bhardwaj, Delhi (IN); Jatin Katyal, Murphy, TX (US); David C. White, Jr., St. Petersburg, FL (US)

(21) Appl. No.: 19/095,225

(22) Filed: Mar. 31, 2025

(51) Int. Cl. H04N 7/15; G06V 10/70; G10L 15/26

(52) U.S. Cl. CPC H04N 7/155; G06V 10/70; G10L 15/26

(57) ABSTRACT

Methods, devices, and systems generate a comprehensive summary of a collaboration session in which summary from an audio transcript is integrated with summarized shared content, thus ensuring that both audio and visual data are adequately represented in the comprehensive summary. A method may involve a summarization service obtaining a multimedia stream of a collaboration session in which at least two participants collaborate via respective user devices and content is being shared in the collaboration session. The method further involves generating metadata about the content based on a time spent on each of one or more segments of content during the collaboration session and a semantic meaning of the one or more segments, and generating a collaboration session summary of the collaboration session using at least a portion of the semantic meaning of the one or more segments of the content based on the metadata and the multimedia stream.

### TECHNICAL FIELD

The present disclosure generally relates to online meeting space environments.

### BACKGROUND

Virtual meeting space environments and video conferencing are popular. Video conferencing typically involves a group of geographically remote participants joining an online meeting via respective user devices for collaboration and content sharing. During video conferencing, video streams of participants are displayed in windows in substantially real-time and content may be shared. Virtual conferencing has further evolved to include various artifacts such as a recording of the video conference, as well as a transcript or a summary of an audio portion of the video conference. Since meeting summaries are typically generated based on the audio portion of the video conference, these meeting summaries may miss data elements presented visually. Audio based summaries may lack context that visual elements would provide and as such may be incomplete and omit important information shared during online meetings by the participants.

### BRIEF DESCRIPTION OF THE DRAWINGS

FIG. 1 is a block diagram illustrating an environment in which a summarization service generates a comprehensive meeting summary of a collaboration session among a plurality of participants, according to an example embodiment.

FIG. 2 is a flow diagram illustrating a summary generation method in which the summarization service of FIG. 1 generates a collaboration session summary (text-visual summary), according to an example embodiment

FIG. 3 is a diagram illustrating a method of generating and updating slide instances metadata for slides, according to an example embodiment.

FIG. 4 is a diagram of a collaboration session summary integrated with visual content, which is generated by the summarization service of FIG. 1, according to an example embodiment.

FIG. 5 is a flowchart illustrating a method of generating a collaboration session summary using at least a portion of the semantic meaning of the content, according to one or more example embodiments.

FIG. 6 is a hardware block diagram of a computing device that may perform functions associated with any combination of operations in connection with the techniques depicted in FIGS. 1-5, according to various example embodiments.

### DESCRIPTION OF EXAMPLE EMBODIMENTS

### Overview

Methods, devices, and systems are provided that generate a comprehensive summary of a collaboration session in which a meeting summary from an audio transcript is integrated with summarized shared content, thus ensuring that both audio and visual data are adequately represented in the comprehensive summary.

In one form, a method is provided that involves a summarization service obtaining a multimedia stream of a collaboration session in which at least two participants collaborate via respective user devices and content is being shared in the established collaboration session. The method further involves generating metadata about the content based on a time spent on each of one or more segments of content during the collaboration session and a semantic meaning of the one or more segments, and generating a collaboration session summary of the collaboration session using at least a portion of the semantic meaning of the one or more segments of the content based on the metadata and the multimedia stream.

### Example Embodiments

Modern video conferencing platforms are popular choices for professional meetings and presentations especially in modern hybrid, remote, and virtual environments. In an online meeting space environment, participants and/or users (these terms are used interchangeably throughout the description) are participating via their respective devices that may be geographically remote from each other. The participants and/or users include humans, bots, and/or other non-human entities such as automated computer systems.

The participant and the respective user (client) device, such as a computer, laptop, tablet, smart phone, etc., may collectively be referred to as endpoints or user devices. The user devices may communicate with each other via one or more networks such as the Internet, virtual private network (VPN), and so on.

The user devices typically have interactive connectivity in a collaboration session. Interactions may include, but are not limited to, manipulating a user interface screen to jump to a particular location, zooming, emphasizing and/or making changes to the actual items and/or objects being displayed such as adding, deleting, and/or editing items and/or objects on the user interface screen, etc.

A collaboration session or an online video conference or an online meeting (these terms are also used interchangeably throughout the description) typically involves two or more participants being connected via their respective user devices in real-time for collaboration. During a collaboration session, the participants are displayed in their respective windows. The audio and/or video of the participants are provided in substantially real-time. The collaboration sessions have evolved to further include many artifacts such as transcripts, gestures, reactions, polls, question and answer (Q&A) sections, location, chats, voting, screen sharing, whiteboards, etc. For example, a canvas or a whiteboard may be provided during the collaboration session for content sharing and co-editing. As another example, a presentation with multiple slides may be shared during the collaboration session by a presenter.

The collaboration session may be summarized and archived for review and/or machine analysis. However, conferencing tools lack capabilities to generate comprehensive meeting summaries that integrate visual content such as slides, charts, and images with audio discussions. Nowadays, video conferencing platforms rely solely on audio-only transcription for summary generation, which neglects context offered by shared content such as slides and/or other visual components. As a result, comprehension of the online meetings becomes fragmented and ineffective, especially in presentations where content such as slides play a pivotal role in the discussions. The inability to monitor and correlate emphasis across multiple data streams during an online meeting results in an ineffective meeting summary that may omit action items, or key data points they are included in the presentation.

Furthermore, in related art, post-meeting processing is performed for generating the summaries, leading to a delayed access of these summaries. Also, these meeting summaries neglect to capture real-time presenter interactions or audience involvement during the collaboration session.

As noted above, in related art, conferencing systems do not track or analyze content shared during the collaboration session. For example, conferencing systems do no track or analyze slides revisited by the presenter during the online meeting, highlighted areas in the slides, or audience questions related to a specific topic or slide. This leads to insufficient prioritization, limiting the identification of crucial aspects or elements of interest. The lack of integrated summaries that incorporate verbal communication, visual components, and participant actions (engagement and interactions) results in discontinuous or insufficient meeting documentation, hindering productivity and subsequent actions. This issue is particularly evident in dynamic presentations where audience interaction and real-time updates are to be considered for comprehension and decision-making. In other words, in related art, conferencing systems fail to effectively monitor and correlate emphasis across multiple data streams. For example, conferencing systems do not track the presenter revisiting slides, highlighting specific areas, or addressing audience questions related to a specific topic or slide. As a result, there is a lack of integration between verbal communication, visual components, and audience engagement.

The techniques presented herein provide a summarization service which generates a Large Language Model (LLM) enhanced meeting summary that integrates audio and shared visual content such as slides in real-time and generates actionable meeting notes. Unlike existing systems that only summarize meetings from audio transcripts and then perform post-processing, the techniques presented herein synchronize visual content being shared during the online meeting with audio via dual timestamping, ensuring that both audio and visual content are accurately recorded and represented in the collaboration session summary. Moreover, the techniques presented herein analyze audio and visual content in substantially real-time (on the fly), throughout the online meeting, and thus provide the generated comprehensive summary after the online meeting without post processing delays.

The techniques presented herein involve the LLM to dynamically assess visual content in substantially real time. The LLM analyzes the content on each slide, for example, including text, images, etc., and assesses its correlation with the audio portion of the ongoing meeting. The visual content is correlated with what the presenter is saying. This correlation provides for synchronizing the slide's main points with audio references even when the presenter moves backward and forward during the meeting. This dynamic slide-audio correlation may generate a comprehensive meeting summary that focuses on main points of both visual and audio content of the meeting.

While one or more example embodiments describes LLM, the disclosure is not limited thereto. Other machine learning (ML)/artificial intelligence (AI) models are within the scope of this disclosure. Other ML/AI tools such as neural networks, natural language processing, unsupervised and supervised machine learning, may be deployed depending on a particular use case scenario.

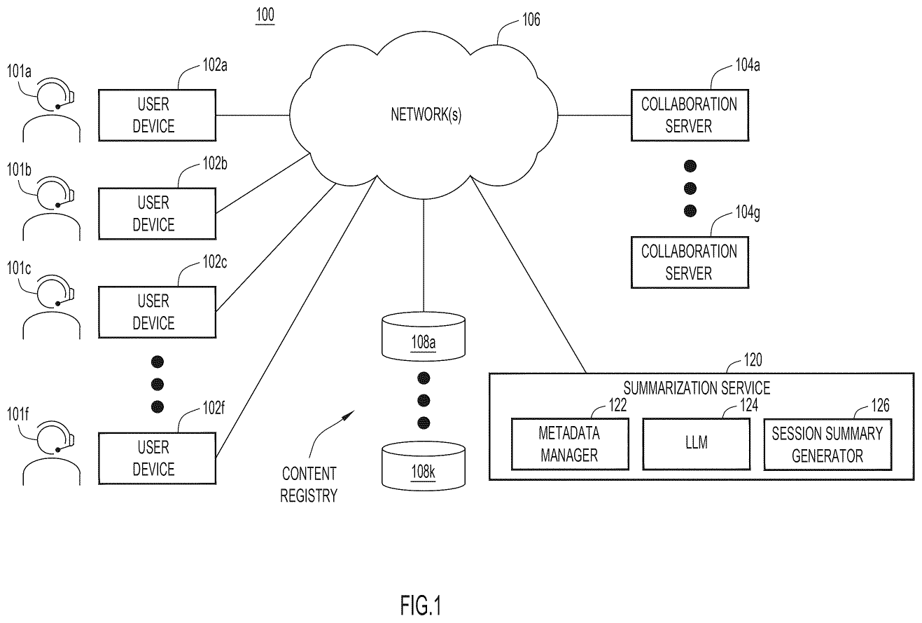

Referring now to FIG. 1, FIG. 1 is a block diagram illustrating an environment 100 in which a summarization service 120 is deployed for generating a comprehensive meeting summary of a collaboration session among a plurality of participants, according to an example embodiment. The environment 100 includes a plurality of participants 101a-f, a plurality of user devices (devices) 102a-f, a plurality of collaboration servers 104a-g, a network 106 (or a collection of networks), one or more databases 108a-k (or a content registry) that store metadata about content, and a summarization service 120 having a metadata manager 122 for generating and updating metadata, an LLM 124 and a session summary generator 126 for generating comprehensive meeting summaries. In one example embodiment, the LLM 124 may be an external AI entity or tool and is not part of the summarization service 120.

The notations “a-f”, “a-g”, “a-k”, “a-m”, “a-n”, “a-q”, “a-p”, “a-r”, “a-s”, “a-t” and the like denote that a number is not limited, can vary widely, depends on a particular use case scenario, and need not be the same, in number. Moreover, this is only an example of various collaboration sessions, and the number and types of sessions and collaboration session summaries may vary based on a particular deployment and use case scenario.

In the environment 100, one or more users/participants may be participating in a collaboration session (depicted as a first participant 101a, a second participant 101b, a third participant 101c, and a fourth participant 101f). The participants 101a-f use their respective devices 102a-f (depicted as a first endpoint device 102a, a second endpoint device 102b, a third endpoint device 102c, and a fourth endpoint device 102f) to participate in a collaboration session.

The collaboration servers 104a-g and the devices 102a-f communicate with each other via the network 106. The network 106 may include a local area network (LAN), a wide area network (WAN) such as the Internet, or a combination thereof, and includes wired, wireless, or fiber optic connections. In general, the network 106 can use any combination of connections and protocols that support communications between the entities of the environment 100.

The collaboration servers 104a-g (depicted as a first collaboration server 104a and a second collaboration server 104g) manage and control collaboration sessions. The devices 102a-f communicate with the collaboration servers 104a-g to join and participate in the collaboration session. The collaboration servers 104a-g retrieve and control distribution of various content from the databases 108a-k and media streams of the collaboration session to the devices 102a-f.

The collaboration servers 104a-g further store identifiers of various collaboration sessions that may be obtained from the databases 108a-k (one or more memories or datastores), depicted as a first database 108a and a second database 108k. The collaboration servers 104a-g are configured to communicate with various client applications executing on the devices 102a-f. The client applications running on the devices 102a-f detect various actions performed by the respective participants during a collaboration session and notify the respective collaboration server associated with the collaboration session about these events. The respective collaboration server may render or display, in a collaboration space and/or on a user interface screen of the respective device, one or more contents of the collaboration session. That is, one of the collaboration servers 104a-g sends commands to the client applications running on the devices 102a-f to render content in a particular way, to change views, controls, and so on. One of the collaboration servers 104a-g may capture participant actions (engagement and interactions) during the collaboration session and provide to the summarization service 120. In short, the collaboration servers 104a-g control the collaboration sessions by communicating and/or interacting with client applications running on the devices 102a-f that detect various actions performed by the participants 101a-f during the collaboration sessions and execute commands and/or instructions for the collaboration sessions as provided by the collaboration servers 104a-g.

In one or more example embodiments, the collaboration servers 104a-g further communicate with the summarization service 120 via the network 106. The collaboration servers 104a-g provide, to the summarization service 120, various data such as multimedia stream of an ongoing collaboration session (video stream and/or audio stream) and content shared during the collaboration session. Content may include one or more of images, documents, charts, slides, and the like. These are just some non-limiting examples of various content that may be shared during an established or an ongoing collaboration session. The content shared may depend on a type of deployment and use case scenario (e.g., a screen, whiteboard, power point presentation).

Additionally, the collaboration servers 104a-g may monitor activities occurring in collaboration sessions. These activities may involve in-meeting commands and/or reactions from one or more participants 101a-f via respective devices 102a-f. In-meeting commands may involve emphasizing (highlighting), editing, deleting, adding, etc., a portion of the displayed content. Reactions relates to the participant's engagement activities with respect to the displayed content. It may be in a form of audio phrases, emojis, chat comments, question and answer (Q & A) session, etc. The collaboration servers 104a-g may adjust the ongoing collaboration sessions based on the in-meeting commands and provide reactions to the summarization service 120 along with the multimedia stream of the collaboration session.

In one example embodiment, the summarization service 120 may directly communicate with the client applications running on the devices 102a-f via the network 106 to obtain the multimedia stream, content being shared, and participant actions in the ongoing collaboration session. The summarization service 120 obtains a multimedia stream of a collaboration session, content is being shared in the collaboration session, and/or any in-meeting commands, user reactions, etc. The summarization service 120 uses the metadata manager 122 and the LLM 124 for generating and updating metadata about the content based on time spent on the content and semantic meaning of the content. The collaboration session summary of the ongoing collaboration session is then generated, by the session summary generator 126 using the LLM 124, using at least a portion of the semantic meaning of the content (or one or more segments of the content) based on the metadata and the multimedia stream.

Specifically, the metadata manager 122 performs dual timestamping of an audio portion of the collaboration session and one or more segments of the content being shared during the collaboration session. That is, the metadata manager 122 tags one or more audio phrases with a timestamp using Automatic Speech Recognition (ASR) of the audio portion of the multimedia stream. Alternatively, the LLM 124 may add metadata tagging and timestamps based on the input audio signal. The metadata manager 122 divides content being shared into multiple segments (e.g., slides of a presentation) and records each occurrence of the one or more segments of the content during the collaboration session tagged with an entry and exit timestamps (generates a slide instance). The entry and exit timestamps indicate the beginning of the sharing of the segment and a stop of the sharing of the segment, respectively.

The LLM 124 correlates an occurrence of a segment or slide with the one or more audio phrases based on the dual timestamping. As such, metadata is generated that further includes parameters of the occurrence of the segment. That is, metadata for an occurrence of the segment (slide instance) stored in the content registry (databases 108a-k) may include: (1) a unique identifier of the slide, (2) timestamps such as an entry timestamp when beginning to share the slide during the collaboration session and an exit timestamp when stopped sharing the slide, (3) semantic meaning of the slide, (4) link to images in the slide and/or a link to the slide itself, and (5) priority metrics such as participants' engagement and actions with the slide. In one example embodiment, the LLM 124 may be deployed for image processing to determine semantic meaning of images in the segment of the content (slide). The metadata may be in a form of a key-value structure for each occurrence of the segment, as discussed below.

In short, using the LLM 124, the metadata manager 122 may generate an occurrence of a segment (a slide instance) as soon as the slide is being presented during the collaboration session. The metadata manager 122 may further update the occurrence of the segment when the presenter begins speaking. The metadata manager 122 uses the LLM 124 to determine if a slide is being newly presented or revisited. Additionally, the metadata manager 122 may identify and generate an additional slide instance if the presenter refers to the content of a previously displayed slide. Moreover, the metadata manager 122 calculates priority metrics by aggregating emphasis, interaction, and engagement data. The metadata manager 122 may calculate priority metrics while updating an exit timestamp for the current slide instance.

The session summary generator 126 uses the LLM 124 to generate a comprehensive collaboration session summary based on the metadata and the multimedia stream. The collaboration session summary represents audio and visual content and their relevance based on a dynamic slide-audio correlation that involves dual timestamping. With the help of the LLM 124, content registry is created and updated along with priority metrics (on the fly or substantially in real-time) to avoid post processing delays. The collaboration session summary includes impactful content that was shared during the session while omits slides or segments of the content that may be background or were briefly mentioned. For example, a segment of the content with metadata indicating that the total time spent is less than a threshold (e.g., ten seconds) and/or that the segment had no participant engagement may be omitted by the session summary generator 126 that uses the LLM 124 when generating the collaboration session summary, as discussed below.

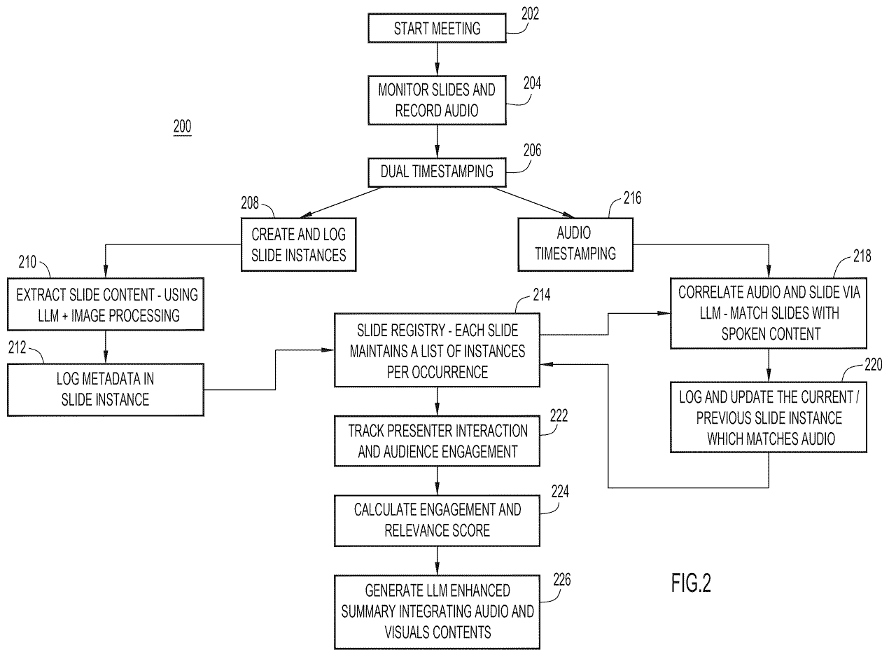

With continued reference to FIG. 1, FIG. 2 is a flow diagram illustrating a summary generation method 200 in which the summarization service 120 generates a collaboration session summary (text-visual summary), according to an example embodiment. The summarization service 120 obtains from one of the collaboration servers 104a-g, multimedia stream of an ongoing collaboration session including content being shared and other artifacts (participant actions with respect to the content being shared). The summarization service 120 uses the LLM 124 to generate the collaboration session summary that integrates audio and shared content, in real-time and based on their relevance, as follows.

The summary generation method 200 begins at 202, with one of the collaboration servers 104a-g initiating an online meeting or establishing a collaboration session.

At 204, the collaboration server may monitor content being presented (e.g., slides) and may record audio and video of the established collaboration session, generating a multimedia stream.

At 206, dual timestamping is performed in which the content being shared is time stamped (an entry and exit time stamps when beginning to share and stopped to share) and the audio portion of the established collaboration session is also timestamped i.e., tagged with respective timestamp(s). By performing dual timestamping, content aware summaries may be generated. In other words, dual timestamping helps correlate content being shared with an audio portion of the collaboration session.

Specifically, at 208, an instance or an occurrence of a segment of the content is detected and an occurrence entry or record (slide instance) is generated. The generated occurrence entry is logged, recorded, or stored in the visual content registry (one of the databases 108a-k) with a unique identifier. At 210, content metadata is extracted from the segment by the LLM 124 performing machine learning analysis and by performing image processing of the images and/or layout of the slide. The content metadata may include semantic meaning for the segment (slide instance) and time spent on the segment based on an entry timestamp when a participant begins to share the segment and an exist timestamp when the participant stopped sharing the segment. At 212, the content metadata is added to the stored occurrence entry in the visual content registry. As such, at 214, the visual content registry includes a plurality of occurrences of segments (slide instances). Each segment metadata maintains a list of instances per occurrence, which is correlated with an audio portion of the established collaboration session, as explained with reference to operations 216, 218, and 220.

Specifically, at 216, the audio portion of the multimedia stream of the collaboration session is converted to an audio transcript (text) using Automatic Speech Recognition (ASR) and audio phrases are timestamped or tagged with a timestamp (audio timestamping). This is just an example. The LLM 124 may be a multi-modal LLM that consumes raw audio data as input and adds metadata. In other words, in one example embodiment, the audio is not translated into text first and the audio data is input into the LLM 124.

At 218, the LLM 124 correlates the audio portion (phrases) with segments (slides) using the LLM 124. In other words, segments of the content (slides) are aligned with text in the audio transcript based on information in the visual content registry. At 220, the slide instances in the visual content registry are updated based on the correlations performed at 218. For example, the current and/or previous slide instance that matches the audio is updated. The operations 216, 218, and 220 highlight the audio transcription and timestamping process in which an audio portion of the established collaboration session is aligned or correlated with content being shared during the established collaboration session. For example, portions of the text in the audio transcript (phrases) are correlated with various segments of content such as slides of a presentation.

Additionally, the summary generation method 200 includes generating priority metrics. Segments of the content are analyzed and prioritized based on their relevance. The relevance of a segment may be determined based on participants interactions with the segment and participants engagement. For example, presenter interactions and audience engagement metrics are tracked and logged into one of the databases 108a-k, as segment metadata and are then used to calculate emphasis and engagement scores, and the overall relevance score. As such, some slides may be prioritized based on presenter's interactions with these slides and audience engagement metrics. That is, with both presenter and audience interactions, the summarization service 120 gages contextual relevance metrics.

Specifically, at 222, the summarization service 120 tracks presenter's interactions (actions performed with respect to the segment of the content currently being shared) and audience engagement (questions asked, comments made, emojis, etc.). At 224, the summarization service 120 calculates an engagement score based on the tracked audience engagement and an emphasis score based on the presenter's interactions with the segment. As such, the summarization service 120 gages contextual relevance of segment(s) of the shared content. It should be noted that the summarization service 120 generates contextual relevance metrics in real-time or on the fly during the collaboration session.

At 226, these inputs are integrated by the LLM 124 to generate a comprehensive meeting summary (the collaboration session summary). The summarization service 120 generates the LLM-enhanced meeting summary for visual and text content in part based on the priority metrics. A collaboration session summary integrates audio and visual content and their relevance. Specifically, portions and details for the collaboration session summary may be determined based on the priority metrics. For example, a phrase describing a first segment of the content may be added to the collaboration session summary based on a low relevance score while a paragraph may be added to the collaboration session summary for a second segment of the content with high relevance score. A third segment of the content that was briefly mentioned by the presenter or indicated as background, may be omitted from the collaboration session summary as being less than a time threshold and/or less than a relevance threshold.

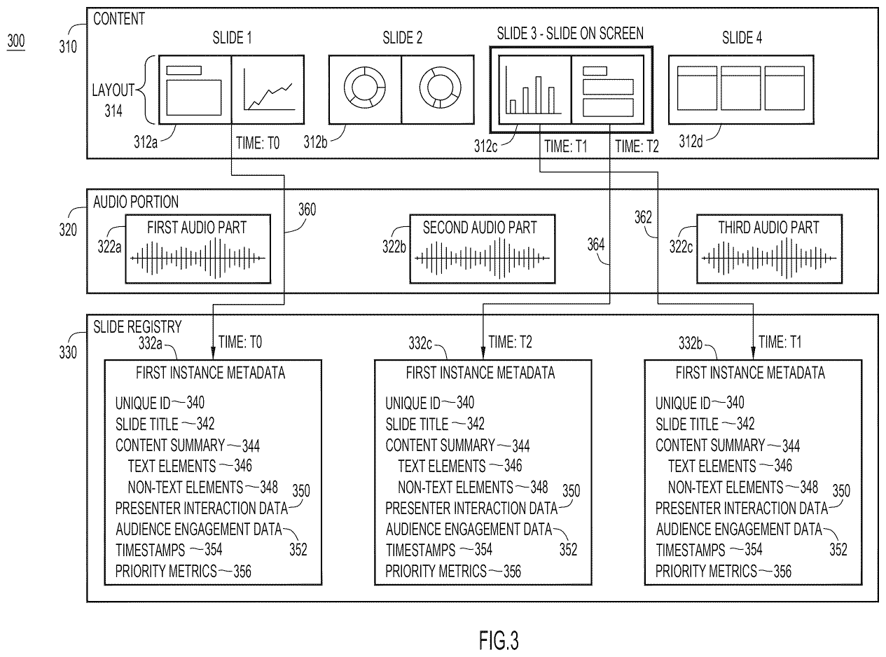

With continued reference to FIGS. 1 and 2, FIG. 3 is a diagram illustrating a method 300 of generating and updating slide instances metadata for slides, according to an example embodiment. The method 300 involves content being shared during the collaboration session (content 310), an audio portion 320 of a multimedia stream of the collaboration session, and a slide registry 330 that stores metadata about content. The summarization service 120 generates and stores the metadata about content in the slide registry 330 based on the content 310 and the audio portion 320.

By way of an example only, the content 310 may be a presentation, a document, a white board that includes visual aids such as slides and/or infographics. As an example, the content 310 is a presentation document that includes a first slide 312a, a second slide 312b, a third slide 312c, and a fourth slide 312d. Slides 312a-d are content segments that are being shared by a presenter during a collaboration session. The slides 312a-d may include images, drawings, text, etc. The slides 312a-d include a layout 314 such as a book layout, bullet points layout, an outline layout, images layout, etc.

The audio portion 320 includes a plurality of phrases, which are tagged with a timestamp using Automatic Speech Recognition (ASR). The Automatic Speech Recognition (ASR) may further convert speech to text transcript and analyze the text transcript to match with the shared content. For example, the audio portion 320 includes a first audio part 322a, a second audio part 322b, and a third audio part 322c. To correlate slides 312a-d to audio parts 322a-c, audio-slide timestamping (dual timestamping) is performed. That is, spoken phrase(s) are tagged with a timestamp using Automatic Speech Recognition (ASR) such as the first audio part 322a is tagged with a timestamp T0, the second audio part 322b is tagged with the timestamp T1, and the third audio part 322c is tagged with the timestamp T2. Dual timestamping synchronization may enable accurate correlation between the slides 312a-d and phrases or audio parts 322a-c.

Additionally, a slide registry 330 is maintained that records metadata about content. Specifically, for each occurrence or instance of the slides 312a-d that is detected, a metadata instance is generated. In other words, each slide instance is logged with metadata in the slide registry 330 such as a first instance metadata 332a, a second instance metadata 332b, and a third instance metadata 332c.

A slide may have multiple slide instances in at least two scenarios: (1) when the presenter revisits and displays the slide again or (2) when the presenter references content from a previously displayed slide, even without revisiting the slide (displaying the slide again). Whether the slide is displayed again or mentioned later on in the presentation, a slide instance metadata is generated.

Each of the slide instance metadata 332a-c may be logged using a key-value structure to ensure a well-organized representation of the content. Each of the slide instance metadata 332a-c may include one or more parameters such as headings, sub-headings, bullet points, and non-text elements. For non-text elements (e.g., images, charts, or tables), the LLM 124 of FIG. 1 and image processing techniques are used to extract relevant insights. These parameters are further associated with sub-attributes such as a mention count value, audio timestamps (when beginning to present the slide and when stopping to present the slide), presenter activities (e.g., pointer movements, highlights, edits, etc.), and audience engagement. This key-value-based logging structure ensures that relevant aspects of the slide are effectively logged, contextualized, and preserved for accurate synchronization and prioritization in the comprehensive collaboration session summary.

In one or more example embodiments, each of the slides 312a-d is identified with a unique identifier (ID) 340, which is stored in a respective slide instance metadata. Additionally, each of the slide instance metadata 332a-c includes parameters such as a slide title 342, content summary 344 having text elements 346, non-text elements 348, presenter interaction data 350, audience engagement data 352, timestamps 354, and priority metrics 356. At each occurrence of the slide (mentioned or display), a new slide instance metadata is generated.

Specifically, the method 300 includes, at time “T0”, the presentation begins, and slide 1 is displayed on the screen during the collaboration session. As such, at 360, a first instance metadata 332a for the first slide 312a is generated and added to the slide registry. Since this is a first occurrence of the first slide 312a, the unique ID 340 is generated. The first instance metadata 332a has an entry timestamp “T0”. Since the first audio part 322a matches with the first slide 312a, the timestamps 354 include mention count and a mentioned timestamp. The mention count and the mentioned timestamp may be specific to particular element(s) of the first slide 312a. The LLM 124 generates content summary 344 for the text elements 346 and the non-text elements 348. The first instance metadata 332a further tracks presenter actions in the presenter interaction data 350 and other participant's actions (questions, comments, emojis, etc.) in the audience engagement data 352. Based on the presenter interaction data 350 and the audience engagement data 352, the priority metrics 356 may be generated, discussed below.

Next, at time “T1”, the third slide 312c is presented. As such, at 362, a new metadata instance for the third slide 312c is generated and added to the slide registry 330, as the second instance metadata 332b. The second instance metadata 332b has a different unique ID 340 and an entry timestamp “T1”. When the spoken content matches the content of the displayed slide, the corresponding parameters in the slide's metadata are updated. Specifically, the second audio part 322b matches the third slide 312c and mention count and mention timestamps are updated in the second instance metadata 332b.

However, at time “T2”, the presenter discusses content related to a topic, which corresponds to the first slide 312a (even though it is not currently displayed), the summarization service 120 thus searches for matches in previously visited slides using the LLM 124. In this scenario, instead of updating the existing metadata of the first slide 312a (the first instance metadata 332a), a new metadata instance is generated for the first slide 312a as a third instance metadata 332c. That is, at 364, since the third audio part 322c matches content of the first slide 312a, the third instance metadata 332c is generated. Since this is not a first occurrence of the first slide 312a, the third instance metadata 332c has the same unique ID 340 as the first instance metadata 332a. However, the entry timestamp is “T2”. The first instance metadata 332a remains unchanged to preserve the correlation with its original timestamp and ensure accurate calculation of the total duration spent on each slide. Based on entry and exit timestamps of each instance metadata for a slide, the summarization service 120 calculates of the total time spent on the slide. This approach maintains consistency and prevents discrepancies in the metadata about content.

In one or more example embodiments, if one of the slides 312a-d is revisited, the summarization service 120 detects this by sending the new slide content to the LLM 124 for evaluation. The LLM 124 determines whether the slide has been previously visited by analyzing its content and the layout 314. If a match is found, the LLM 124 retrieves the unique ID 340 from the existing metadata in the slide registry 330. A new slide instance is then created under this same unique ID, ensuring accurate tracking of revisited slides. If no match is found, a new slide instance is created with a new unique ID 340 as the next incremental value from the highest available ID in the slide registry 330. This ensures that slides 312a-d are uniquely identified and logged, whether they are new or revisited.

The summarization service 120 ensures valid slide instances by discarding slides where the total duration spent on a slide is less than 10 seconds threshold, for example, such as when slides are quickly bypassed during navigation e.g., the second slide 312b for which no instance metadata is generated. The 10 seconds threshold is provided by way of an example only, the number may be less. Additionally, since the LLM 124 is monitoring the audio and is associating the audio to a slide, if nothing is mentioned on a slide, then the slide does not need to appear in the summary because nothing was said about the slide and the slide was not referenced. The second slide 312b is omitted from generating the collaboration session summary because the time spent was less than a threshold.

In generating the collaboration session summary, the summarization service 120 is further configured to prioritize portions of the content based on the priority metrics 356. For example, the summarization service 120 prioritizes slides with a high relevance score calculated using a combination of the presenter interaction data 350 and the audience engagement data 352, and timestamps 354 (time spent on the slide).

Audience engagement data 352 may include metrics such as number and content of question and answer (Q&A) sessions, audience responses such as hand raising, chat communications, and emojis. For example, if a slide contains an illustration that generates multiple audience questions, it is flagged as highly relevant. These engagement metrics, when combined with presenter actions like pointer movements or highlights, help determine the overall priority (relevance score) of the slide in the collaboration session summary.

One of the slides 312a-d is considered a high priority if it receives audience questions, comments, or significant presenter emphasis. For instance, a slide featuring a bar chart that is frequently referenced in the audio portion 320, visually highlighted by the presenter, and extensively discussed during the Q&A session by the audience, is ranked higher and is assigned a high priority score. This ensures that the collaboration session summary prominently displays the impactful slides, making the collaboration session summary actionable and relevant.

Timestamps 354 are recorded not only to measure the duration spent on each of the slides 312a-d but to assist with calculating priority metrics 356. For example, timestamps for audience engagement metrics is used to calculate an engagement score. The priority metrics 356 aggregate emphasis, interaction, and engagement data to compute the relevance score, ensuring that the slide's relevance to the collaboration session is accurately reflected in the collaboration session summary. As such, the key-value structure of the instance metadata 332a-c may enhance contextual understanding of the slides 312a-d by integrating presenter actions and audience interactions within each field, enabling a more accurate and actionable prioritization.

As an example, the first instance metadata 332a for the first slide 312a may be as follows.

```
  {
  “slide_id”: “slide_04”,
  “title”: “Key Metrics for Project Success”,
  “content_summary”: {
    “text_elements”:
    {
          “type”: “bullet_point”,
          “text”: “Budget Efficiency: Staying within allocated
          resources”,
          “mention_count”: 3,
          “mentioned_timestamp”: “00:00:10”,
          “highlighted”: true,
          “presenter_interactions”: {
                “pointer_movements”: [
                {
                  “interaction_duration”: “00:00:10”,
                  “interaction_timestamp”: “00:00:15”,
                }
              ]
              “highlighted”: yes
              }
          }
        ]
      “non_text_elements”: [
  {
        “type”: “chart”,
        “label”: “Chart 1”,
            “description”: “Bar chart showing performance of different
teams against key metrics”,
        “mentioned_timestamp”: “00:00:20”,
        “storage_path”: “/slides/slide_04/images/chart_l.png”,
  ....
  ....
  }
  ]
  }
  “timestamps”: {
  “entry_timestamp”: “00:12:30”,
  “exit_timestamp”: “00:14:00”,
  “total_time_spent”: “1:30”
  } ,
  “audience_engagement”: {
    “q_and_a_sessions”: [
  {
    “question”: “Can you elaborate on the budget efficiency metric?”,
    “asked_by”: “Audience Member 1”
    “timestamp”: “00:00:20”
      }
    ]
  “engagement_score”: 85
  } ,
  “priority_metrics”: {
    “emphasis_score”: 20,
    “engagement_score”: 85,
    “relevance_score”: 105
  }
  }
```

The first instance metadata 332a includes both textual and visual components. For instance, the bullet point “Budget Efficiency: Staying within allocated resources” was highlighted and engaged with a pointer for 10 seconds. Non-text elements, such as a bar chart labeled “Chart 1”, are also logged along with the engagement and interaction details.

In one example embodiment, if participants have rankings, these ranking may be considered and factored into the relevance score. For example, actions of a client participant with a rank level 1 may be ranked higher than actions of a provider participant with a rank level 2. In such cases, engagement by the client participant may result in a higher engagement score than engagement by the provider participant. As another example, manager participants may have a higher rank level in a team. In other words, the summarization service 120 may assign weights in calculating the priority metrics 356 based on a participant rank level.

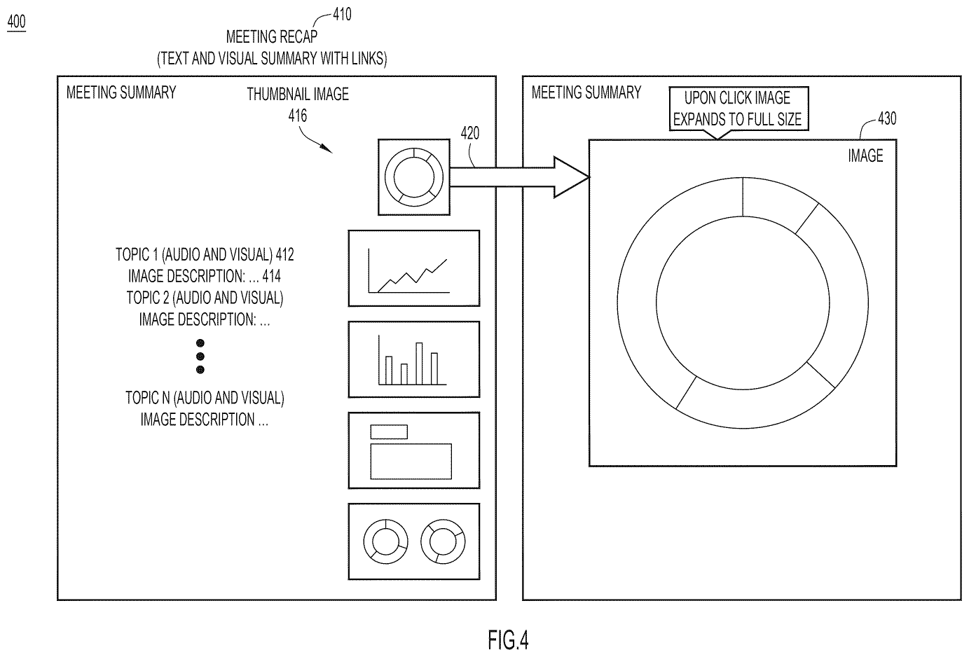

With continued reference to FIGS. 1-3, FIG. 4 is a view illustrating a collaboration session summary 400 integrated with visual content, which is generated by the summarization service 120 of FIG. 1, according to an example embodiment. The collaboration session summary 400 includes a meeting recap 410 of the audio portion of the multimedia stream of the collaboration session and the shared content (such as a document or a presentation). The collaboration session summary 400 further includes an image 430 available for selection in the meeting recap 410.

Specifically, the meeting recap 410 has a semantic summary 412 about the audio portion and the shared content. The semantic summary may be topic specific such as semantic summaries of topics 1-n discussed during the collaboration session. Each topic includes an image description 414 of the shared content (e.g., infographics) for the respective topic, which may be embedded with a link to the full size visual data/infographic of the shared content. Each topic may further include a thumbnail image 416 of infographic. That is, visual content or visual aids may be displayed next to the related topic at a reduced size. As such, visual content summary is integrated into the meeting recap 410. The meeting recap 410 is detailed and context-rich at least because the meeting recap 410 includes visual data of the content being shared during the collaboration session and corresponding descriptions.

By clicking on a link in the meeting recap 410, shown at 420, the image 430 may be displayed in its full size, as it appeared during the collaboration session. For example, the image 430 may be an enlarged view of a relevant slide of the presentation for detailed inspection by a user.

The disclosure is not limited to slide presentations. The disclosure includes any content that may be shared during a collaboration session. By way of an example and as noted above, content may involve documents, code, websites, videos, and/or infographics. Further, the visual content may be a subset of what is being shared on the screen.

The techniques presented herein provide an LLM enhanced meeting recap that integrates audio and shared content in real time to generate actionable and contextually rich meeting notes or collaboration session summary.

The techniques presented herein, unlike traditional systems that rely solely on audio transcripts, utilize the LLM to dynamically evaluate content being shared including (but not limited to) text, graphics, and charts and integrate the shared content with audio references. Specifically, the techniques employ dual timestamp-based synchronization to align audio parts (phrases) with content events, ensuring that the collaboration session summary accurately represents the actual flow and context, even when segments of the content are reviewed or displayed out of order. In other words, the techniques presented herein use ML/AI models to analyze visual content being shared during the collaboration session, extract relevant data and align the extracted data with audio portion of the multimedia stream of the collaboration session. As such, the enriched collaboration summary may be presented in a cohesive document that provides a semantic summary of audio and shared visual content in the collaboration session.

The techniques presented herein capture comprehensive information for each collaboration session (e.g., a presentation), including participant actions such as presenter interactions, audience participation, and time spent on each segment, facilitating the prioritization of content being shared based on relevance and significance.

The techniques presented herein may integrate participant actions and compute priority metrics such as a relevance score based on monitoring or tracking Q&A sessions, chat interactions, emojis and/or presenter activities such as pointer movements and highlights. The data points provide a relevance score, ensuring that high-priority segments of the content, which draw considerable audience interest and presenter attention, are prominently shown in the collaboration session summary. The relevance score further ensures that irrelevant segments of the content such as background, appendix only briefly mentioned, etc., are omitted from the collaboration session summary.

The techniques presented herein generate the collaboration session summary in real time (or on the fly) during the ongoing collaboration session. As such, the organized, actionable collaboration session summary is sent promptly after the collaboration session without post processing delays. The collaboration session summary includes key points, prioritized images, and insights extracted from the presentation.

The techniques presented herein may provide for real-time collaboration session summaries that allow professionals to enhance productivity and accurately record/recall key information from the meeting whether this information is provided in a visual format, audio format, and/or text format. The techniques presented herein uses LLM and image processing to generate meaningful semantic summary of the content in various formats presented during the meeting.

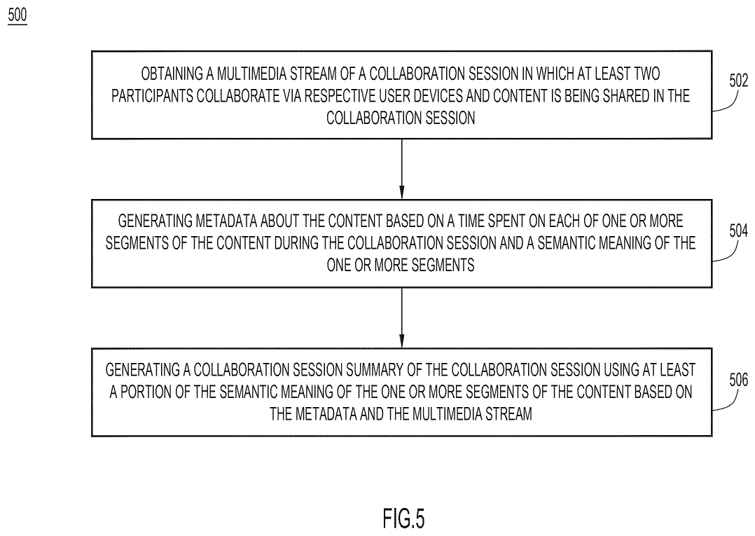

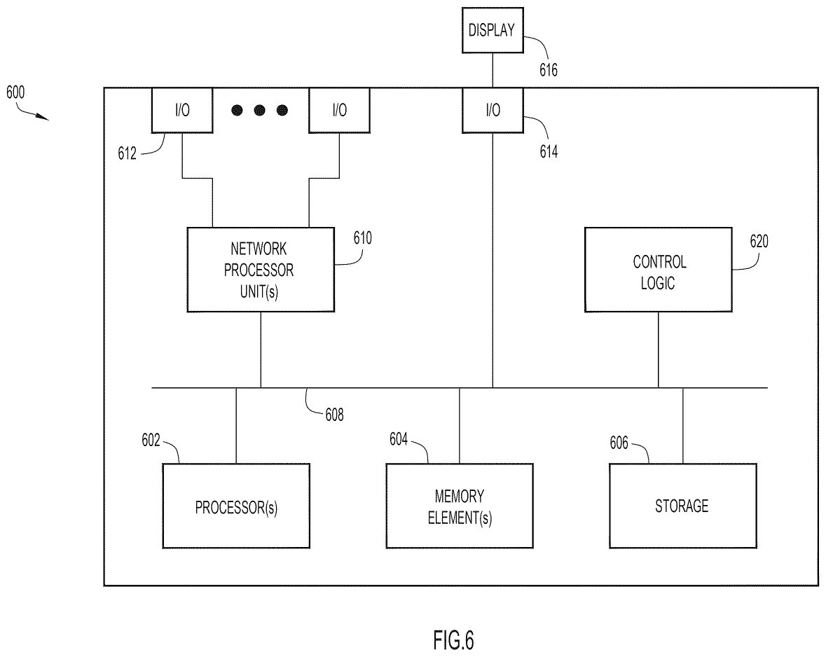

Turning now to FIG. 5, FIG. 5 is a flowchart illustrating a method 500 of generating a collaboration session summary using at least a portion of the semantic meaning of the content, according to one or more example embodiments. The method 500 may be performed by an apparatus or a computing device of FIG. 6 and/or one or more servers that implement the system described above with reference to FIGS. 1-4, and/or in the cloud, for example, by the summarization service 120 of FIG. 1.

The method 500 involves at 502, obtaining, by a summarization service, a multimedia stream of a collaboration session in which at least two participants collaborate via respective user devices and content is being shared in the established collaboration session.

The method 500 further involves at 504, generating metadata about the content based on a time spent on each of one or more segments of the content during the collaboration session and a semantic meaning of the one or more segments.

The method 500 further involves at 506, generating a collaboration session summary of the collaboration session using at least a portion of the semantic meaning of the one or more segments of the content based on the metadata and the multimedia stream.

In one form, the method 500 may further involve tagging one or more audio phrases with a timestamp using Automatic Speech Recognition (ASR) of an audio portion of the multimedia stream. The operation 504 of generating the metadata about the content may involve recording each occurrence of the one or more segments of the content during the collaboration session and correlating an occurrence of a segment of the one or more segments with the one or more audio phrases based on the timestamp.

In one instance, the operation 504 of generating the metadata about the content may involve recording an entry timestamp when beginning to share the content for each of the one or more segments during the collaboration session and an exit timestamp when stopping to share the content for each of the one or more segments during the collaboration session. The operation 504 of generating the metadata about the content may further involve calculating the time spent on each of the one or more segments based on the entry timestamp and the exit timestamp for each occurrence of the one or more segments of the content during the collaboration session.

According to one or more example embodiments, the one or more segments may include at least one image. The operation 504 of generating the metadata about the content may further involve determining the semantic meaning of the one or more segments of the content using image processing.

According to one or more example embodiments, the operation 504 of generating the metadata about the content may further involve generating a key-value structure for each occurrence of the one or more segments of the content. The key-value structure may include a unique identifier, the semantic meaning, the entry timestamp, the exit timestamp, and one or more priority metrics.

In another instance, the operation 504 of generating the metadata about the content may involve detecting an occurrence of a segment of the one or more segments during the collaboration session and determining whether the occurrence is a first occurrence of the segment of the one or more segments during the collaboration session by performing machine learning for the semantic meaning of the segment and by performing image processing of a layout of the segment. The operation 504 of generating the metadata about the content may further involve, based on determining that the occurrence is the first occurrence of the segment, generating a unique identifier for the segment and based on determining that the occurrence is not the first occurrence of the segment, obtaining the unique identifier for the segment from the metadata of a previous occurrence of the segment. The operation 504 of generating the metadata about the content may further involve generating a key-value structure for the occurrence of the segment. The key-value structure may include the unique identifier and parameters of the occurrence of the segment.

In another form, the method 500 may further involve determining whether to include the semantic meaning of a segment of the one or more segments into the collaboration session summary based on one or more priority metrics of the segment.

In yet another form, the method 500 may further involve segmenting the content into a plurality of segments, each including visual data. The method 500 may further involve tracking one or more actions of the at least two participants during the collaboration session. The one or more actions include interactions with a respective segment by the at least two participants and reactions to the respective segment from the at least two participants. The method 500 may further involve determining one or more priority metrics of each of the plurality of segments based on the one or more actions. The operation 504 of generating the collaboration session summary may be based on the one or more priority metrics.

According to one or more example embodiments, the operation 506 of generating the collaboration session summary may involve omitting a segment of the one or more segments of the content from the collaboration session summary based on the time spent being less than a threshold.

According to one or more example embodiments, the content being shared during the collaboration session may include a document or a slide presentation each including text and image data.

FIG. 6 is a hardware block diagram of a computing device 600 that may perform functions associated with any combination of operations in connection with the techniques depicted in FIGS. 1-5, according to various example embodiments, including, but not limited to, operations of an apparatus such as an endpoint device of the endpoint devices 102a-f, a collaboration server of the collaboration servers 104a-g, and/or the summarization service 120. It should be appreciated that FIG. 6 provides only an illustration of one example embodiment and does not imply any limitations with regard to the environments in which different embodiments may be implemented. Many modifications to the depicted environment may be made.

In at least one embodiment, computing device 600 may include one or more processor(s) 602, one or more memory element(s) 604, storage 606, a bus 608, one or more network processor unit(s) 610 interconnected with one or more network input/output (I/O) interface(s) 612, one or more I/O interface(s) 614, and control logic 620. In various embodiments, instructions associated with logic for computing device 600 can overlap in any manner and are not limited to the specific allocation of instructions and/or operations described herein.

In at least one embodiment, processor(s) 602 is/are at least one hardware processor configured to execute various tasks, operations and/or functions for computing device 600 as described herein according to software and/or instructions configured for computing device 600. Processor(s) 602 (e.g., a hardware processor) can execute any type of instructions associated with data to achieve the operations detailed herein. In one example, processor(s) 602 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, one or more memory element(s) 604 and/or storage 606 is/are configured to store data, information, software, and/or instructions associated with computing device 600, and/or logic configured for memory element(s) 604 and/or storage 606. For example, any logic described herein (e.g., control logic 620) can, in various embodiments, be stored for computing device 600 using any combination of memory element(s) 604 and/or storage 606. Note that in some embodiments, storage 606 can be consolidated with one or more memory elements 604 (or vice versa) or can overlap/exist in any other suitable manner.

In at least one embodiment, bus 608 can be configured as an interface that enables one or more elements of computing device 600 to communicate in order to exchange information and/or data. Bus 608 can be implemented with any architecture designed for passing control, data and/or information between processors, memory elements/storage, peripheral devices, and/or any other hardware and/or software components that may be configured for computing device 600. In at least one embodiment, bus 608 may be implemented as a fast kernel-hosted interconnect, potentially using shared memory between processes (e.g., logic), which can enable efficient communication paths between the processes.

In various embodiments, network processor unit(s) 610 may enable communication between computing device 600 and other systems, entities, etc., via network I/O interface(s) 612 to facilitate operations discussed for various embodiments described herein. In various embodiments, network processor unit(s) 610 can be configured as a combination of hardware and/or software, such as one or more Ethernet driver(s) and/or controller(s) or interface cards, Fibre Channel (e.g., optical) driver(s) and/or controller(s), and/or other similar network interface driver(s) and/or controller(s) now known or hereafter developed to enable communications between computing device 600 and other systems, entities, etc., to facilitate operations for various embodiments described herein. In various embodiments, network I/O interface(s) 612 can be configured as one or more Ethernet port(s), Fibre Channel ports, and/or any other I/O port(s) now known or hereafter developed. Thus, the network processor unit(s) 610 and/or network I/O interface(s) 612 may include suitable interfaces for receiving, transmitting, and/or otherwise communicating data and/or information in a network environment.

I/O interface(s) 614 allow for input and output of data and/or information with other entities that may be connected to computing device 600. For example, I/O interface(s) 614 may provide a connection to external devices such as a keyboard, keypad, a touch screen, and/or any other suitable input device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor 616, a display screen, or the like.

In various embodiments, control logic 620 can include instructions that, when executed, cause processor(s) 602 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

In another example embodiment, an apparatus is provided. The apparatus includes a memory, a network interface configured to communicate in a network, and a processor coupled to the network interface. The processor is configured to perform a method, which includes obtaining a multimedia stream of a collaboration session in which at least two participants collaborate via respective user devices and content is being shared in the collaboration session. The method further involves generating metadata about the content based on a time spent on each of one or more segments of the content during the collaboration session and a semantic meaning of the one or more segments. The method further involves generating a collaboration session summary of the collaboration session using at least a portion of the semantic meaning of the one or more segments of the content based on the metadata and the multimedia stream.

In yet another example embodiment, one or more non-transitory computer readable storage media encoded with instructions are provided. When the media is executed by a processor, the instructions cause the processor to execute a method, which includes obtaining a multimedia stream of a collaboration session in which at least two participants collaborate via respective user devices and content is being shared in the collaboration session. The method further includes generating metadata about the content based on a time spent on each of one or more segments of the content during the collaboration session and a semantic meaning of the one or more segments. The method further includes generating a collaboration session summary of the collaboration session using at least a portion of the semantic meaning of the one or more segments of the content based on the metadata and the multimedia stream.

In yet another example embodiment, a system is provided that includes the devices and operations explained above with reference to FIGS. 1-6.

The programs described herein (e.g., control logic 620) may be identified based upon the application(s) for which they are implemented in a specific embodiment. However, it should be appreciated that any particular program nomenclature herein is used merely for convenience, and thus the embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, the storage 606 and/or memory elements(s) 604 can store data, software, code, instructions (e.g., processor instructions), logic, parameters, combinations thereof, and/or the like used for operations described herein. This includes the storage 606 and/or memory elements(s) 604 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi 6®), IEEE 802.16 (e.g., Worldwide Interoperability for Microwave Access (WiMAX)), Radio-Frequency Identification (RFID), Near Field Communication (NFC), Bluetooth™, mm. wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc., as discussed for various embodiments described herein may be performed among entities that may directly or indirectly connected utilizing any algorithms, communication protocols, interfaces, etc., (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc., which may be inclusive of packets. As referred to herein, the terms may be used in a generic sense to include packets, frames, segments, datagrams, and/or any other generic units that may be used to transmit communications in a network environment. Generally, the terms reference to a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
obtaining, by a summarization service, a multimedia stream of a collaboration session in which at least two participants collaborate via respective user devices and content is being shared in the collaboration session;
generating metadata about the content based on a time spent on each of one or more segments of the content during the collaboration session and a semantic meaning of the one or more segments; and
generating a collaboration session summary of the collaboration session using at least a portion of the semantic meaning of the one or more segments of the content based on the metadata and the multimedia stream.

2. The method of claim 1, further comprising:
tagging one or more audio phrases with a timestamp using Automatic Speech Recognition (ASR) of an audio portion of the multimedia stream,
wherein generating the metadata about the content includes:
recording each occurrence of the one or more segments of the content during the collaboration session; and
correlating an occurrence of a segment of the one or more segments with the one or more audio phrases based on the timestamp.

3. The method of claim 2, wherein generating the metadata about the content further includes:
recording an entry timestamp when beginning to share the content for each of the one or more segments during the collaboration session and an exit timestamp when stopping to share the content for each of the one or more segments during the collaboration session; and
calculating the time spent on each of the one or more segments based on the entry timestamp and the exit timestamp for each occurrence of the one or more segments of the content during the collaboration session.

4. The method of claim 3, wherein the one or more segments include at least one image, and generating the metadata about the content further includes:
determining the semantic meaning of the one or more segments of the content using image processing.

5. The method of claim 4, wherein generating the metadata about the content further includes:
generating a key-value structure for each occurrence of the one or more segments of the content, wherein the key-value structure includes a unique identifier, the semantic meaning, the entry timestamp, the exit timestamp, and one or more priority metrics.

6. The method of claim 1, wherein generating the metadata about the content includes:
detecting an occurrence of a segment of the one or more segments during the collaboration session;
determining whether the occurrence is a first occurrence of the segment of the one or more segments during the collaboration session by performing machine learning for the semantic meaning of the segment and by performing image processing of a layout of the segment;
based on determining that the occurrence is the first occurrence of the segment, generating a unique identifier for the segment;
based on determining that the occurrence is not the first occurrence of the segment, obtaining the unique identifier for the segment from the metadata of a previous occurrence of the segment; and
generating a key-value structure for the occurrence of the segment, wherein the key-value structure includes the unique identifier and parameters of the occurrence of the segment.

7. The method of claim 1, further comprising:
determining whether to include the semantic meaning of a segment of the one or more segments into the collaboration session summary based on one or more priority metrics of the segment.

8. The method of claim 1, further comprising:
segmenting the content into a plurality of segments, each including visual data;
tracking one or more actions of the at least two participants during the collaboration session, wherein the one or more actions include interactions with a respective segment by the at least two participants and reactions to the respective segment from the at least two participants; and
determining one or more priority metrics of each of the plurality of segments based on the one or more actions,
wherein generating the collaboration session summary is based on the one or more priority metrics.

9. The method of claim 1, wherein generating the collaboration session summary includes:
omitting a segment of the one or more segments of the content from the collaboration session summary based on the time spent being less than a threshold.

10. The method of claim 1, wherein the content being shared during the collaboration session includes a document or a slide presentation each including text and image data.

11. An apparatus comprising:
a memory;
a network interface configured to enable network communications; and
a processor, wherein the processor is configured to perform a method comprising:
obtaining a multimedia stream of a collaboration session in which at least two participants collaborate via respective user devices and content is being shared in the collaboration session;
generating metadata about the content based on a time spent on each of one or more segments of the content during the collaboration session and a semantic meaning of the one or more segments; and
generating a collaboration session summary of the collaboration session using at least a portion of the semantic meaning of the one or more segments of the content based on the metadata and the multimedia stream.

12. The apparatus of claim 11, wherein the processor is further configured to perform:
tagging one or more audio phrases with a timestamp using Automatic Speech Recognition (ASR) of an audio portion of the multimedia stream,
wherein the processor is configured to generate the metadata about the content by:
recording each occurrence of the one or more segments of the content during the collaboration session; and
correlating an occurrence of a segment of the one or more segments with the one or more audio phrases based on the timestamp.

13. The apparatus of claim 12, wherein the processor is configured to generate the metadata about the content further by:
recording an entry timestamp when beginning to share the content for each of the one or more segments during the collaboration session and an exit timestamp when stopping to share the content for each of the one or more segments during the collaboration session; and
calculating the time spent on each of the one or more segments based on the entry timestamp and the exit timestamp for each occurrence of the one or more segments of the content during the collaboration session.

14. The apparatus of claim 13, wherein the one or more segments include at least one image, and wherein the processor is configured to generate the metadata about the content further by:
determining the semantic meaning of the one or more segments of the content using image processing.

15. The apparatus of claim 14, wherein the processor is configured to generate the metadata about the content further by:
generating a key-value structure for each occurrence of the one or more segments of the content, wherein the key-value structure includes a unique identifier, the semantic meaning, the entry timestamp, the exit timestamp, and one or more priority metrics.

16. The apparatus of claim 11, wherein the processor is configured to generate the metadata about the content by:
detecting an occurrence of a segment of the one or more segments during the collaboration session;
determining whether the occurrence is a first occurrence of the segment of the one or more segments during the collaboration session by performing machine learning of the semantic meaning of the segment and by performing image processing of a layout of the segment;
based on determining that the occurrence is the first occurrence of the segment, generating a unique identifier for the segment;
based on determining that the occurrence is not the first occurrence of the segment, obtaining the unique identifier for the segment from the metadata of a previous occurrence of the segment; and
generating a key-value structure for the occurrence of the segment, wherein the key-value structure includes the unique identifier and parameters of the occurrence of the segment.

17. One or more non-transitory computer readable storage media encoded with software comprising computer executable instructions that, when executed by a processor, cause the processor to perform a method including:
obtaining a multimedia stream of a collaboration session in which at least two participants collaborate via respective user devices and content is being shared in the collaboration session;
generating metadata about the content based on a time spent on each of one or more segments of the content during the collaboration session and a semantic meaning of the one or more segments; and
generating a collaboration session summary of the collaboration session using at least a portion of the semantic meaning of the one or more segments of the content based on the metadata and the multimedia stream.

18. The one or more non-transitory computer readable storage media according to claim 17, wherein the computer executable instructions cause the processor to further perform:
tagging one or more audio phrases with a timestamp using Automatic Speech Recognition (ASR) of an audio portion of the multimedia stream,
wherein the computer executable instructions cause the processor to generate the metadata about the content by:
recording each occurrence of the one or more segments of the content during the collaboration session; and
correlating an occurrence of a segment of the one or more segments with the one or more audio phrases based on the timestamp.

19. The one or more non-transitory computer readable storage media according to claim 18, wherein the computer executable instructions cause the processor to generate the metadata about the content further by:
recording an entry timestamp when beginning to share the content for each of the one or more segments during the collaboration session and an exit timestamp when stopping to share the content for each of the one or more segments during the collaboration session; and
calculating the time spent on each of the one or more segments based on the entry timestamp and the exit timestamp for each occurrence of the one or more segments of the content during the collaboration session.

20. The one or more non-transitory computer readable storage media according to claim 19, wherein the one or more segments include at least one image, and wherein the computer executable instructions cause the processor to generate the metadata about the content further by:
determining the semantic meaning of the one or more segments of the content using image processing.
